(19) United States
(12) Patent Application Publication
(10) Pub. No.: US 2021/0004896 A1
(43) Pub. Date: Jan. 7, 2021

(54) Method and system for automated account balancing and credit rating exploitation

(71) Applicant: Justin Gannon, Lafayette, LA (US)

(72) Inventor: Justin Gannon, Lafayette, LA (US)

(21) Appl. No.: 16/503,597

(22) Filed: Jul. 4, 2019

(51) Int. Cl. G06Q 40/02; G06Q 40/06; G06Q 20/02; G06Q 20/08

(52) U.S. Cl. CPC G06Q 40/02; G06Q 20/0855; G06Q 20/023; G06Q 40/06

(57) ABSTRACT

Generally speaking, the invention provides for credit score maximization, by streamlining a user's credit and debit decisions in accordance with preselected parameters. A user can be a person or a business, and parameters can be manipulated by interface with a mobile or desktop application, online portal, or other such mechanism. When a transaction occurs at a merchant POS, the amount is processed by an algorithm that determines how that payment can be distributed between the user's available accounts to meet that user's desired account portfolio. Methods are provided for use of a temporary credit facility and a related payment device that will yield seamless integration, and in the spirit of credit rating exploitation, prevent overdraft or debt default fees, and negative credit marks with the major credit bureaus. The systems and methods described herein provide for a means of splitting a payment between two different accounts, or a plurality of accounts, to achieve a desired credit portfolio using only a single card, or other payment device such as a mobile phone app at a POS terminal, and split between them as per that user's credit scoring needs, or other credit related concern. The same can occur vice versa for a deposit transaction or other cash inflow, to distribute that deposit between a plurality of accounts, or mixture of both deposit, and credit accounts, with the respective portion of the deposit used to pay down credit card account balances.

### TECHNICAL FIELD

The field of the invention relates to account management, and credit scoring systems. In particular to a method and system of raising credit scores, managing account balances, and preventing overdraft fees, streamlined and done automatically. Any type of account can be used in the systems and methods described herein.

### BACKGROUND OF THE INVENTION

This relates to bank accounts and credit accounts, specifically payment accounts operated by use of a card the user carries on his person or by an application on a mobile device that communicates with a point of sale terminal (POS), or account numbers entered through an internet connection and online portal. Credit scoring and financial management is at the core of modern-day commerce. Generally speaking, credit ratings and scores are based on a person or firm's overall level of debt, and holdings of assets and equity. Credit scores are calculated from a number of different consumer credit bureaus, also called reporting agencies. Equifax, Experian, and TransUnion are the three major U.S. consumer credit bureaus, as well as CIC and JICC in Japan, Callcredit in Europe, where they are often called public registries, and countless others abroad in addition to the three major U.S. bureaus which operate internationally. Fair Isaac Corporation's FICO score is a popular metric used to determine whether or not credit shall be extended to a consumer, and also the interest they will pay on that credit. A FICO score comes from information harvested from said bureaus and applies a numerical score to the likelihood a consumer would default on a debt obligation, thus are frequently used in making credit decisions. While often referred to as a score in regard to consumer credit, when referring to a firm or corporation's credit-worthiness, such a score is usually called a credit rating. Standard &Poors (S&P), Moody's, and Fitch Group are some of the largest U.S. commercial credit rating agencies, as well as Japan Credit Rating Agency in Japan, AMBERS in Europe, and countless others abroad, which all tend to operate internationally. A firm's credit rating is generally pertaining to the solvency of the firm in regard to stocks, bonds, and other debt instruments a firm may issue to finance its operations. These ratings come from mathematical formulas factored from data in financial statements, credit and bank account balances, and securities markets and prices.

Also of concern to a discussion of credit and banking decisions is the credit card payment process. The customer provides card information to a merchant at a POS, which can be swiping a card at a terminal, giving numbers over the phone, given at an online portal, or a prescheduled automatic payment. The merchant's payment processing terminal electronically sends the card number, transaction amount and merchant ID number to the merchant's acquirer, which is a financial entity the merchant hires to route payment information to the correct parties and ensure that funds are deposited into the merchant's accounts after a transaction is complete. The acquirer routes the information to the customer's issuing bank, which is the bank that provided the payment card and account to the customer, and this serves as a request to authorize the transaction for the specified amount. The issuing bank checks that the customer has adequate funds or credit to cover the payment, then the issuer sends an authorization code through the card network to the acquirer. The acquirer authorizes the transaction and informs the merchant, then the merchant provides the goods or services to the customer. At the close of the business day the merchant sends all the payment information collected throughout the day to his acquirer, and the acquirer sends the information to the card network, which is a financial entity that facilitates payment processing at a POS, also known as a card association (Visa, Mastercard, American Express, Discover), then the card network requests payment for the transaction from the customer's issuing bank. Finally, the issuing bank routes payment through the card network to the acquirer, which pays the merchant.

The modern-day consumer holds so many different accounts with varying institutions that balancing them as desired sometimes consumes a great deal of time and energy. Similar problems exist for a firm's finance manager, as access to many payment accounts and lines of credit may often prove an unwieldy and arduous task. Balancing accounts to meet credit scoring goals further complicates matters. Inventors have sought to remedy some of these concerns.

In conclusion, insofar as I'm aware, no such prior art exists providing for a method and system that allows a consumer or firm to streamline his credit management by linking two accounts, or a plurality of accounts, so at POS transactions he need only concern himself with a single payment card or device from a single account, and still have access to all funds from all of his available accounts. Further, a method and system of granting a consumer or firm access to every last penny of available funds in his aggregated accounts in such a manner he will never incur an overage fee until after his last penny is spent, and such result rendered from the simplicity of a single payment card or device. I also found no prior art pertaining to automated account balancing, nor any that seeks to achieve a maximum credit score also automatically. For these outcomes, the present invention aims to serve every type of firm or consumer, and the unique and specific methods by which my system operates, I believe this application should overcome all prior art claims in the field.

### SUMMARY OF THE INVENTION

Generally speaking, the invention provides for streamlining a user's credit and banking decisions. The user of the invention can be a person, or a business, though we describe the invention's benefits as applicable to a consumer, the same principles are also applicable to a business setting, and the word “consumer” can be replaced with the word “business” with no alteration to the spirit of the invention as described. When a transaction occurs at a merchant POS the transaction amount is processed by an algorithm that determines how that payment would best be distributed between the user's available accounts to better meet that user's desired account portfolio than if it were processed normally. This can be achieved by offsetting a payment transaction from one account, with a payment charged to another account, and paid to the original payment account to recoup some or all of the dollar amount of the original transaction, thus distributing the payment across his available accounts. Were it a deposit, or other cash inflow, the same can occur, where a deposit can be distributed by transferring portions of the total amount to other bank accounts, or possibly using some of it to pay down the balance on a credit card account. Such decisions can be automated so that on each transaction, be it a payment or a deposit, the transaction is automatically distributed between available accounts in a manner chosen by the user according to preselected parameters, while the user is not troubled beyond simply swiping a card, or other such means of routing a single payment or deposit.

Thus, every account linked to these systems and methods should be monitored constantly, around the clock, and without fail, to be sure no overage fees occur. As we shall see, such protection from overage and overage fees is implicit in the benefits manifested by the present invention. Consideration for the possibility an account is subject to monthly account maintenance fees should also be taken, as well as any other types of fees a user may incur (such as currency exchange fees, check fees, monthly fees if account balance falls below a certain dollar amount, etc.), to be sure these other types of fees (that are not related to overage) also do not occur unless need be, as they may be the cause an overdraft, or otherwise make the benefits of such distribution less than the costs. All these and other types of account fees should be guarded against and factored in to the systems and methods that determine how a payment or deposit transaction should best be distributed, and funds should be transferred to protect against such fees before or whenever they might occur. These distributions of a transaction can be processed in accordance with a mathematical algorithm, which could be written into software housed at a central server that is connected to banking networks and payment systems, as well as connections to the internet for communication with the user via a graphical user interface (GUI). This mathematical algorithm comprises variables which can be manipulated by a user's preference, and input on the GUI, thus allowing the user to control parameters of the distribution. Said GUI can be on his mobile device, desktop PC, or some other device, further, the GUI could even be at the control of an outside person hired to manage the user's portfolio of accounts, or, as in one embodiment of the invention, there could be no interface at all, and the systems and methods of the invention could be entirely automated thus eliminating the need for a GUI.

Said distribution software could also be decentralized and housed on several decentralized servers, or housed on a user's personal device, or on a corporation's own private server, and the GUI can be on the same hardware as the distribution software, or be connected by internet and on a device controlled by the user, or the user's hired account manager, or any place else. The end result will be that daily payment and deposit transactions are distributed amongst any or all of a user's available accounts such as he wished, and he only need concern himself with one payment card or device; and, with the methods and systems implemented as we will discuss, he would have needed to spend every penny in every deposit account, and exhaust the available credit in every credit account he controlled before he was charged and overage fee.

Said automatic distributions need not occur at the immediate time of a transaction, and holds can be placed on (or credits credited to) available funds of accounts targeted by the distribution algorithm until the end of a set period when they are settled (and the period can be one day, or shorter, or any other amount of time as chosen by the user, and or agreed upon by other parties to the systems and methods discussed here). At the end of the period all funds can be charged to or transferred from, as a single payment amount of the aggregate set to be distributed to or from each account to the other, and this would lessen finance charges charged by the financial entities and counterparties involved in the systems and methods of the present invention. It should be said, settlement periods need not be a component of methods of the present invention, and the removal of settlement periods, or even giving the settlement process a permanent period of time in the processes would still be in the spirit of the present invention as described herein.

One possible embodiment of the invention could entail issuance of a special proprietary payment device that routes payment to a merchant as a proxy for the account numbers of his other accounts, with payment passing straight through to a chosen account of the user, or distributed between a plurality of any or all accounts controlled by the user at the same time the proxy payment device pays only a single payment to the merchant. Deposits can also be routed to this proxy payment device where they can then be distributed to the user's other accounts. Another embodiment of the invention provides a line of temporary credit to the user, and if said proxy payment was also issued, the proxy payment device can pay a merchant straight to the temporary credit account to facilitate distribution. Said temporary credit facility can also hold deposits before distribution. If a temporary credit facility can be granted, it should be settled out at the end of the period, and a hold on (or temporary credit to) the targeted accounts which the software algorithm had deemed most suitable to furnish payment (or hold deposit), be placed on or credited to that account, thus facilitating distribution. The line of credit can be settled out at the end of each day, with only a single payment to each of the target accounts. This would greatly facilitate distribution, and could be achieved through use of contracts, or special arrangements with banks and creditors, or possibly with credit card networks (Visa, Mastercard, American Express, etc.). Otherwise, distribution can be facilitated by collateralizing the debt of the period into short term securities traded in highly liquid markets, that can facilitate short term credit needs for minimizing transaction costs, or securities that hold deposits before distribution (like bonds) that pool these short term funds together to achieve more favorable terms in a transaction or provide higher interest rates paid to the user before settlement.

We explain the invention with examples discussing its application to units of dollars, but it may need to be noted, this can refer to any currency, even cryptocurrencies such as bitcoin, or even units of a security, such as stocks, bonds, or SDRs (special drawing rights, which are bonds made from baskets of currencies deposited with the International Monetary fund). If the present invention were applied to a business setting it can be connected to securities exchanges, brokerage accounts, and other such securities trading networks, and a firm's cash or other account it holds in house, and the distribution algorithm can target asset types or classes in addition to bank and credit accounts as discussed above. A firm's needs for this would be many, to include automated credit rating maximization, where a consumer may be needing such for credit score maximization, though a consumer may wish to link brokerage or other financial asset holding accounts (such as a mortgage) to possible targets for automated distribution.

A method according to one embodiment of the invention, the parameters of the distribution algorithm are set to maximize credit scores by distributing a user's daily transactions in accordance with popular credit scoring formulas; for example: many credit scoring formulas deem having credit card account balances at 25 percent of available credit used, thus yielding a higher score, so distribution would aim to charge payments to these accounts until 25 percent of their available credit has been used, or otherwise use deposits to pay down the balances on these accounts until they were at that level. Credit rating agencies base their ratings on metrics such as debt to equity and that ratio arises from the firm's composition of debt and holdings of assets, thus the distribution algorithm can be set to automatically hold a firm's levels of debt and equity at a targeted ratio. A method according to one embodiment, distribution can be set to provide the user with the most favorable interest rates paid to him on deposits, or otherwise charged to him on credit balances. A method according to one embodiment, distribution can be set to charge all purchases to credit, and holding all deposits in bank accounts, thus raising available cash, or the opposite, where transactions are charged to bank deposit accounts, and deposits are used to pay down the balances on credit accounts thus raising available credit. A method according to one embodiment, distribution can set to resolve any other concern the user may have, in some customizable. Any possible of the methods of distributing transactions mentioned could be combined, with priority set to each concern, in any customizable manner, or distribution could be done to meet any other concern not mentioned here, and this would still be in the spirit of the present invention.

In one embodiment of the invention, interface with a country's electronic payments network is provided for so that automated clearing house (ACH) transactions, electronic fund transfers (EFT), or credit card network payments can be arranged for greater control over the composition of a user's debt, as well as cash balances in deposit accounts; this will also allow for automated payment of the user's monthly bills which he normally pays by check, such as rent and mortgage. These monthly bills should be fed through the same distribution algorithm and the payment distributed between the user's accounts in a manner that best meets his needs, while at the same time only a single ACH or EFT payment is made to the merchant. Connections to online banking portals, or other payment systems should also be provided for, and in conjunction with the payment systems mentioned above would better protect the user from fees that could arise due to poor financial management, and further facilitate control over a user's portfolio of account balances.

Further, this invention could be entirely software, and deployed on a businesses' mainframe or desktop computers; a company may decide to make use of this method and system to manage the individual expense accounts of employees in transactions where no money actually changes hands, just is moved from one account to another within the company; or a securities brokerage may deploy a method and system derived from the principles of this invention to safeguard the trades of its brokers against fees; bank could provide the invention to customers as a service; therefore, it is not the intention of this application to limit the scope of the present invention to a specific network architecture, form of business, or other use, so that one could infringe upon the patent should they alter something superficial, such as a decentralized server and network as opposed to the, above-mentioned, “central server,” connected to the related “banking and payment networks,” whereby using a different system of networks, adding a component someplace, or substituting would not be outside the scope of the present invention. There are many variations of hardware, software, and network configuration that could be used to operate an automatic account managing method and system that is not different from that discussed here.

### Technical Problem

The problem which the present invention solves relates to a firm or consumer's need to exploit the benefits of a highest possible credit rating. A consumer or firm's entire composition of debt is included as a factor in credit scoring and rating decisions and managing debt to cash ratios is often an unwieldy and arduous task. A system and method of streamlining and automating this task will yield financial, time saving, and other benefits to the user.

### Solution and Operation

In operation one uses his payment device (be it card, mobile device, or typing numbers into an online portal) the same as he normally would, and this payment device can be a special proxy device (that communicates with online payment systems at a POS terminal) with access to a temporary credit facility, issued by administrators of the systems and methods as described herein. If implemented correctly, the invention provides for complete protection from overage fees, until the last available penny in each and every deposit and credit account has been spent by the user, and further, the only payment device he would ever need carry or concern himself is one, be it the proxy payment device, or any one of his cards to any one of his other accounts (and this can be a credit or debit card, or otherwise held in electronic form as an application on a mobile device, or just remembered card numbers).

A preferred embodiment of the present invention could include a software program running on a central server that would recognize one way or another when a transaction has occurred from a user's account, however systems and methods are described providing for a decentralized network configuration as well. To meet that user's desired credit profile, there could be offsetting credits or debits to and from another account, or plurality of accounts, and done so in accordance with predetermined parameters to meet said credit profile; these would be the benefits manifested from such, and the possible predetermined parameters (though not to be limiting, as there are countless possibilities that would still fall in scope of the present invention), could be:

(1) Distributing a payment or deposit transaction amongst accounts in such a manner so as to maximize the user's credit score or rating by means of account balances, as per FICO or other credit scoring formulas or popular formulas used in rating corporate debt.

(2) Distributing account balances so that the credit or cash portion of transactions is routed to the account, or accounts, with the most favorable interest rates paid to or charged to the user.

(3) Distributing payment transactions between a user's accounts in such a manner that the entire payment is routed to credit accounts, or a credit account, so as to maximize cash in the user's deposit accounts, and similarly, deposit transactions are routed to deposit bank accounts.

(4) Distributing deposit transactions between a user's accounts in such a manner that the entire deposit is used to pay down credit balances in a preselected manner so as to build up available credit, and similarly, payment transactions are charged to deposit bank accounts.

(5) Moving all payments to a specific credit or debit account until it reaches a desired level, and then moving all payments to a next chosen account, and so on and so forth, until the user's desired credit profile has been reached, with each account at the exact level he wishes.

(6) Any other type of customized distribution schema that the user may customize via a GUI on a mobile or desktop application, or other device controlled by the user, or controlled by an outside person hired to manage account balances on the user's behalf.

### INDUSTRIAL APPLICABILITY

The invention is applicable to banking and finance. A bank or a credit card company can use the invention to offer services to a customer that will raise the credit score of a user, and also prevent overdrafts, or otherwise balance the user's composition of debt, and demand deposit accounts. Otherwise, the invention can be offered directly to consumers or businesses.

### PATENT LITERATURE

This application claims the benefit of provisional application Ser. No. 62/739,233, filed on Sep. 30, 2018

### BRIEF DESCRIPTION OF THE DRAWINGS

The above and other mentioned objects and advantages of the present invention will become apparent on consideration of the following detailed descriptions, taken in conjunction with the accompanying drawings, in which like reference characters refer to like parts throughout, and in which:

FIG. 1 is a flow chart illustrating some of the basic steps involved in the streamlined transaction distribution, and automatic balancing of the user's accounts, described in accordance with one embodiment of the present invention.

FIG. 2 is a flow chart illustrating some of the basic steps involved in the streamlined distribution of transactions and automatic balancing of the user's accounts, described in accordance with another embodiment of the present invention which may lack some components of a more preferred embodiment.

FIG. 3 is a flow chart representing some of the basic steps involved in authorizing and processing a transaction when a proxy system has been implemented that makes use of a temporary credit facility, the steps reflecting a more detailed example of a possible method that can be implemented to further facilitate processes of the present invention as it is described in FIG. 1.

FIG. 4A depicts a first example of a possible system configuration for implementing the present invention, in which a payment transaction is automatically distributed amongst any or all of a user's accounts, facilitated by use of a temporary credit facility, and proxy payment device that routes transactions to a special proxy card network.

FIG. 4B depicts a second example of a possible system configuration for implementing the present invention, in which a payment transaction is automatically distributed amongst any or all of a user's available accounts, when the user has not been issued a proxy payment device, nor has a temporary credit facility been granted to the user.

FIG. 4C depicts a third example of a possible system configuration for implementing the present invention, in which a payment transaction is automatically distributed amongst any or all of a user's available accounts, when the user has been issued a proxy payment device that routes payment to a special proxy card network, which can split payments between user accounts while still rendering a single payment to the merchant, without need for a temporary credit facility being granted to the user.

FIG. 4D depicts a fourth example of a possible system configuration for implementing the present invention, in which a payment transaction is automatically distributed amongst any or all of a user's available accounts, by moving funds from other accounts to the original payment account whenever a payment transaction is recognized by systems that monitor for such transactions, and a proxy payment device has been issued to the user.

FIG. 4E depicts a fifth example of a possible system configuration for implementing the present invention, in which the automatic distribution algorithm is not located on a central server, and where it can be an application on a mobile phone or desktop, or a corporation's own private server if the invention were to be applied to a corporate setting.

FIG. 4F is a diagram that depicts an example of the streamlined relationships between elements referred to in methods outlined by the previous flowcharts herein, and in which the graphical user interface manipulates the distribution algorithm, that is triggered whenever the user presents his proxy payment device, or any other payment method, to a merchant at a point of sale, or otherwise when a deposit is routed to the temporary credit facility or any other account controlled by the user.

FIG. 4G depicts a first example of a possible system configuration for implementing the present invention, in which a deposit or cash inflow transaction is automatically distributed amongst any or all of a user's available accounts, facilitated by use of a temporary credit facility, and proxy routing numbers that route funds to a proxy network before they are distributed to other accounts.

FIG. 4H depicts a second example of a possible system configuration for implementing the present invention, in which a deposit or cash inflow transaction is automatically distributed amongst any or all of a user's available accounts, by moving funds to other accounts from the original deposit account whenever a deposit transaction is recognized by systems that monitor all of a user's accounts.

FIG. 5 is a block diagram depicting a first example for implementing systems and methods of the present invention in application to payments, and depicting a sample payment transaction that illustrates how a proxy payment device linked to a proxy network, with a temporary credit facility granted to the user, can be used to automatically distribute that payment transaction amongst any or all of the user's available accounts, thus automatically balancing each of his accounts to meet his needs when processed in accordance with principles of the present invention.

FIG. 6 is a block diagram depicting a second example for implementing systems and methods of the present invention in application to payments, and depicting a sample payment transaction that illustrates how a payment transaction can be automatically distributed amongst any or all of a user's available accounts, by automatically moving funds from other accounts to the original payment account, whenever a payment transaction is recognized by systems that monitor all of a user's accounts, thus automatically balancing each of his accounts to meet his specific needs when processed in accordance with principles of the present invention.

FIG. 7 is a block diagram depicting a first example for implementing systems and methods of the present invention in application to deposits, and depicting a sample deposit transaction that illustrates how a deposit can be routed to a temporary credit facility then ran through the distribution algorithm to be split up between any or all of his accounts, forwarded through the proxy network to be deposited amongst his other targeted accounts, such that each of the user's accounts are automatically balanced to meet his specific needs when processed in accordance with principles of the present invention.

FIG. 8 is a block diagram depicting a second example for implementing systems and methods of the present invention in application to deposits, and depicting a sample deposit transaction that illustrates how a deposit can be distributed amongst any or all of a user's available accounts, by automatically moving funds to other accounts from the original deposit account, whenever a deposit transaction is recognized by systems that monitor all of a user's accounts, thus balancing each account he controls to meet his specific needs when processed in accordance with principles of the present invention.

FIG. 9 is a block diagram depicting an example for implementing systems and methods of the present invention in application to a corporation, and depicting a sample financial market transaction that illustrates how a securities trading loss can be automatically distributed amongst any of a user's available accounts and/or asset classes, through securities purchases, sales, and/or reinvestment, to automatically keep that corporation's debt to equity ratios at levels consistent with a high credit rating, when financial transactions are processed in accordance with principles of the present invention.

FIG. 10 depicts an example of a system configuration for implementing the present invention, the system configuration consisting of software linked to EFT networks, ACH networks, credit card networks (Visa, Discover, American Express, MasterCard, etc.), Fedwire, and other payment and banking networks, in which such network connections monitor all of a user's accounts around the clock to find all payment and deposit transactions, provide real-time account balances, and detect faults that could incur fees that can result from improper account management, and which is implicit in the mechanisms of any system built in accordance with principles of the present invention.

FIG. 11 is a possible sample screen of either the upper half of a mobile phone, or a computer screen, according to another embodiment of the present invention, in which the user manipulates the distribution algorithm by a graphical user interface on a device he controls, although there are several different ways information could be displayed to the user, and several different ways the user could interface with parameters of the distribution algorithm, to include a landline telephone, or a written letter sent in the mail to administrators of the invention, but any combination of these or any other means to control the distribution of transactions, which were not mentioned here would still fall in the scope of the present invention.

### DETAILED DESCRIPTION OF THE DRAWINGS

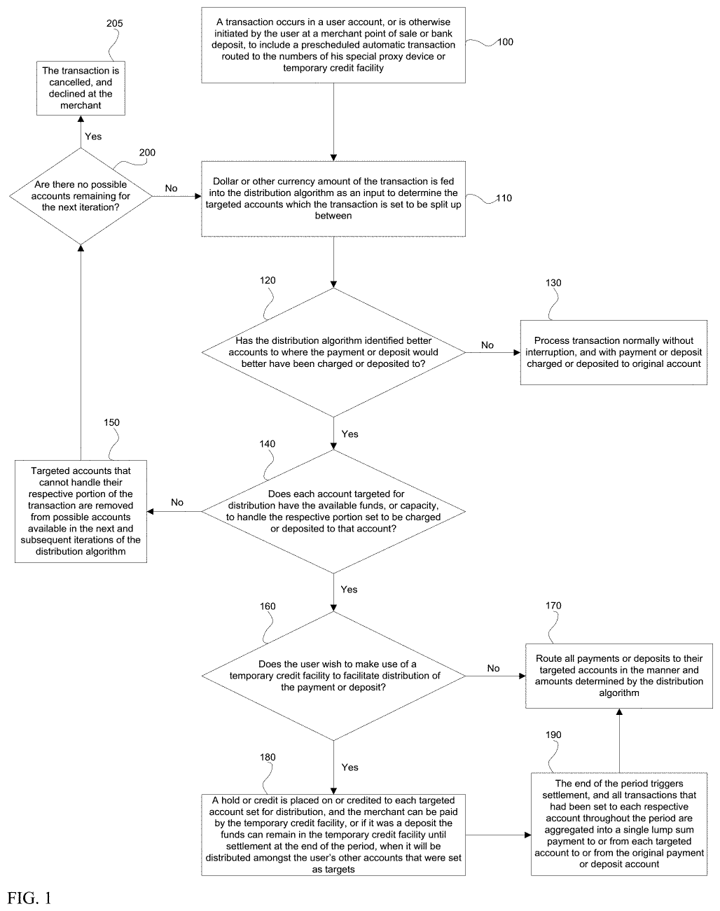

Some embodiments of the present invention are now described in further detail with references to FIGS. 1-11. We explain the invention with examples discussing its application to units of dollars, but it should be noted, this can refer to any currency (even cryptocurrencies, such as bitcoin), or even units of a security (such as stocks, bonds, synthetic securities, or even SDRs). FIG. 1 is a flow chart of the basic steps that occur for each transaction when a preferred embodiment of the present invention has been implemented, and in this embodiment, the user has been granted a temporary credit facility to streamline payment and the distribution of transactions between his other accounts. Further, this temporary credit facility is linked to a special proxy payment device which routes payment information to the merchant's acquirer using a special proxy card network as a proxy for the card networks of the user's issuing banks of his other accounts. This flow chart FIG. 1 describes the possible basic steps that can be taken when the user has been issued this proxy payment device, so that credit authorization requests are first sent to the proxy network, which forwards them to the card networks of the user's other accounts, and returns payment routed to the proxy card network, which then forwards the payment to the merchant's acquirer. This can also occur in reverse, if the user makes a deposit to any of his accounts, or otherwise has a deposit routed to the account numbers of his proxy payment device or temporary credit facility.

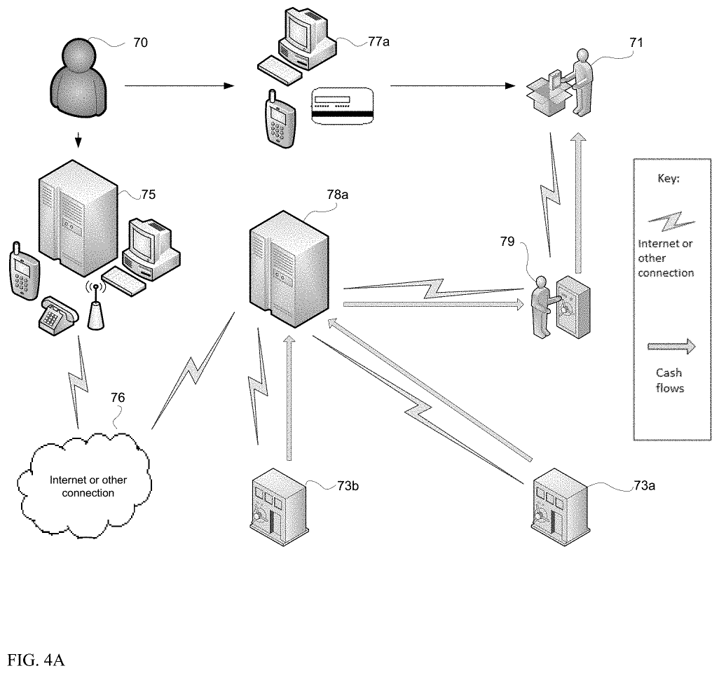

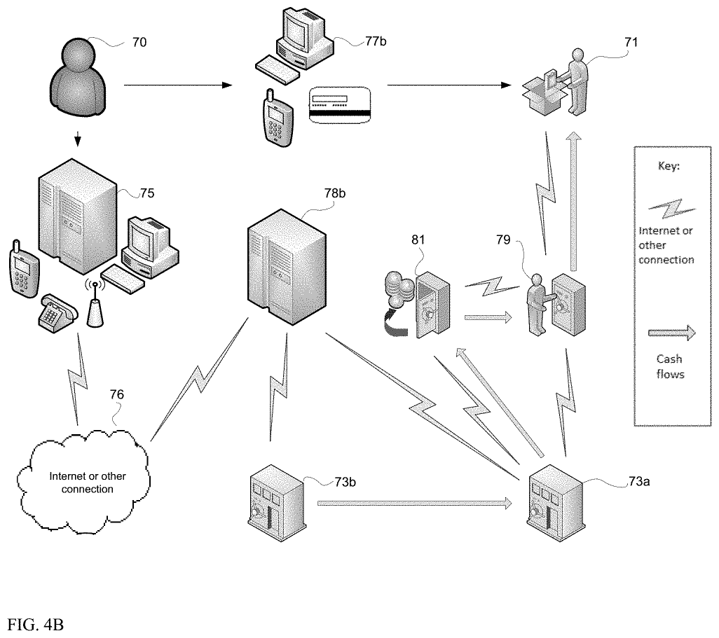

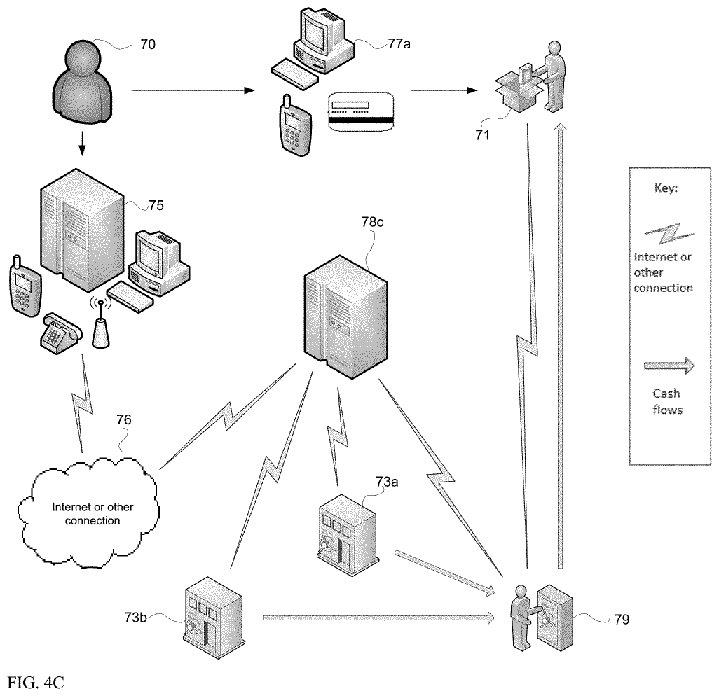

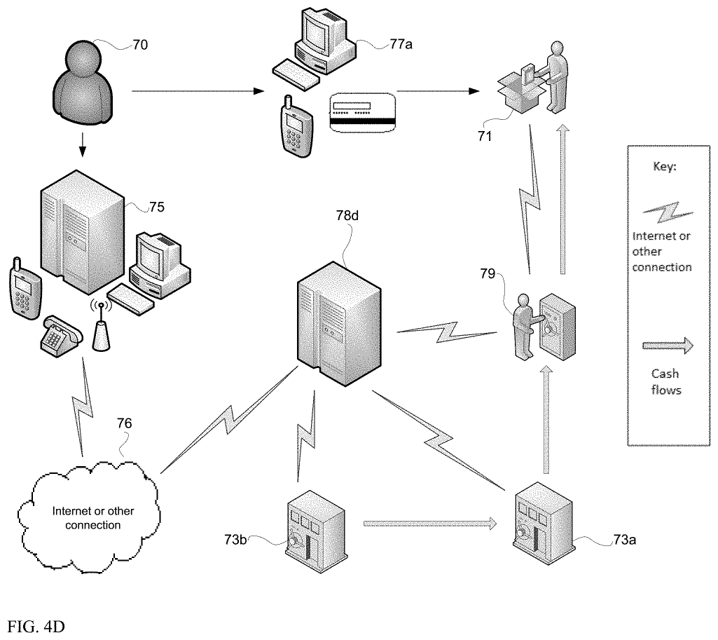

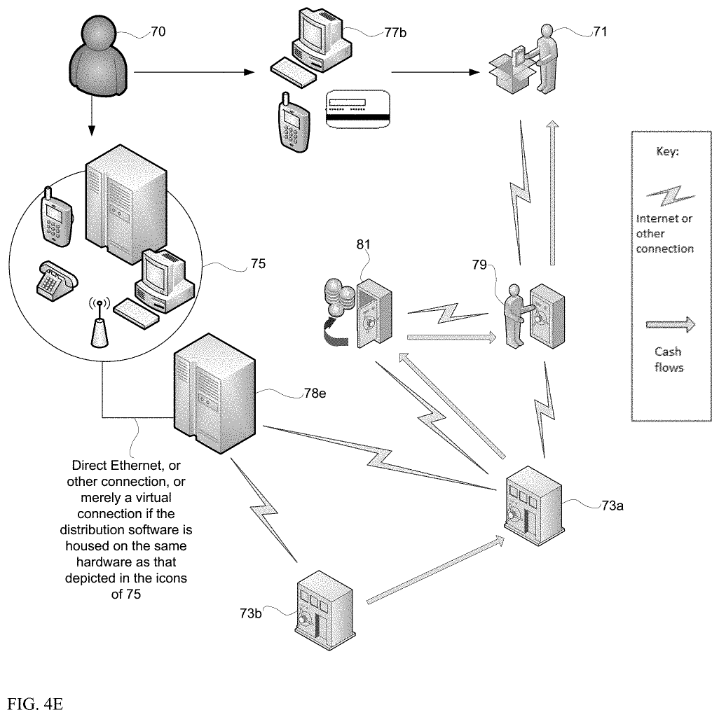

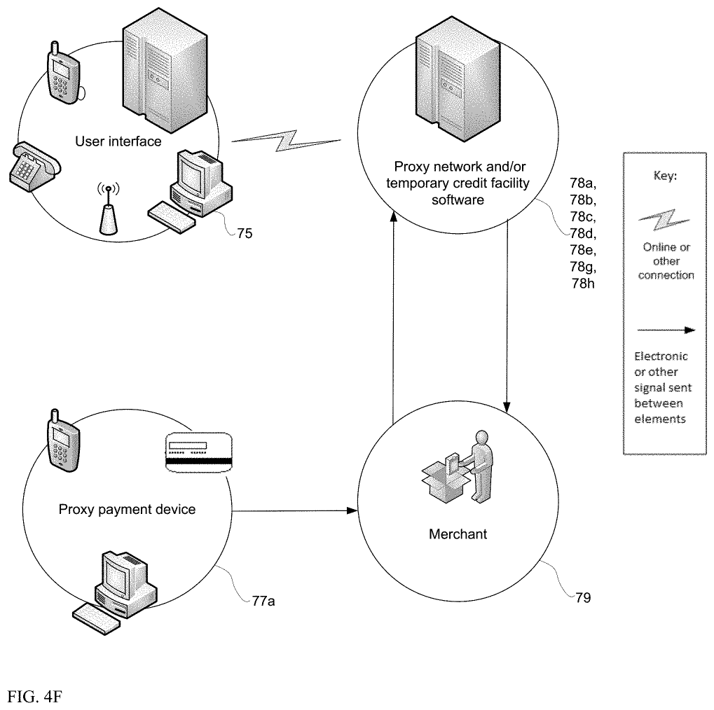

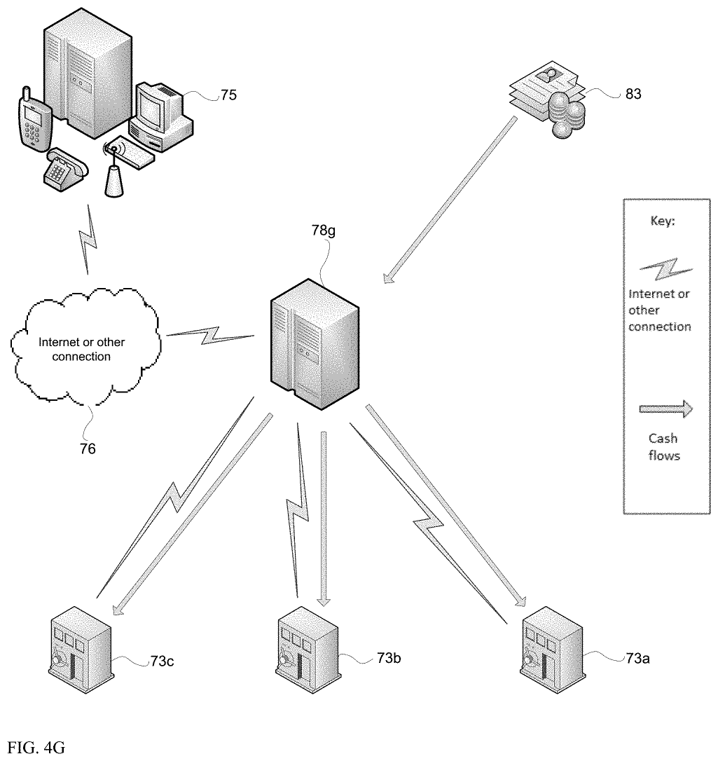

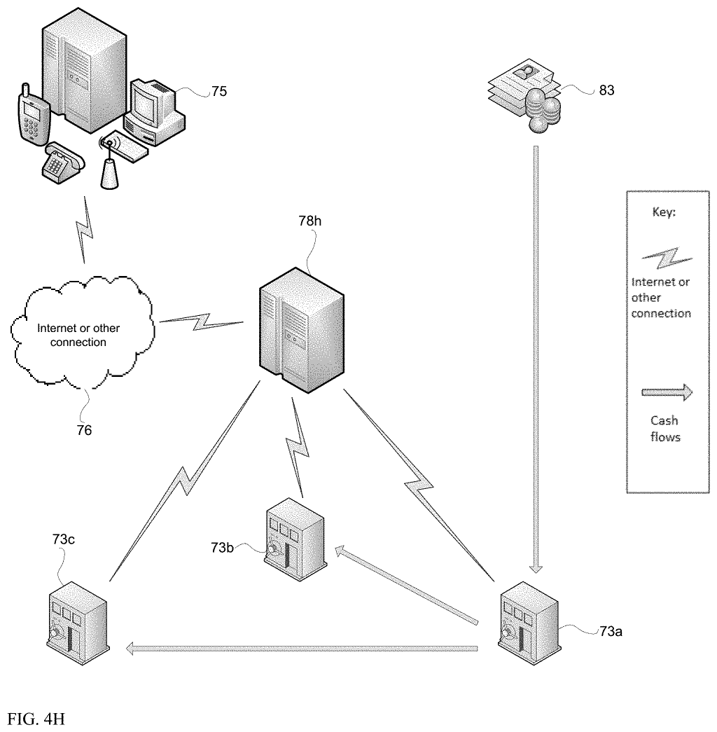

At step 100 of FIG. 1, a transaction has occurred in one of the user's accounts, or otherwise been initiated by the user at a merchant's POS terminal or by a deposit to the proxy payment account or any of his accounts, to include a payment made to pay down the balance of a credit card. At step 110, the dollar amount (or other currency amount) of the transaction is fed into the distribution algorithm as an input. In this embodiment, the distribution algorithm is a software program located on a central server maintained by administrators of the invention, though as shown in later diagrams (FIG. 4E) it can be located elsewhere. It should be noted that not all of a user's available accounts will be possible accounts for distribution, for example, a user may have a credit account issued by a supermarket, which could only be a possible target for distribution when purchases are made from that specific supermarket. If the distribution algorithm has not identified a better account, or accounts, to which the payment or deposit would have better been routed to (at step 120), than it must mean that the original payment or deposit account was the best account for the transaction to be routed to (as per the user's preselected preference chosen on the GUI), thus the transaction is allowed to process normally without interruption, and the process ends at step 130 (it should be noted, the temporary proxy account is meant to be settled at the end of each period, so need not be included in the accounts targeted by the distribution algorithm, though administrators of the invention may decide to give this proxy account a more permanent fixture in the user's overall credit and savings portfolio, and this would still fall in the scope of the present invention's system and methods). If the distribution algorithm has found a better account or plurality of accounts, to include the original account within the plurality (at step 120), to where the payment or deposit would better have been charged or deposited to, or otherwise if the transaction was originally routed to the temporary proxy account to be forwarded to other accounts, these better accounts chosen by the algorithm will be set as the targeted accounts in step 140. The original transaction is set to be charged to the better account, or otherwise split up between two or more of the user's other accounts, with each account set to be charged a portion of the transaction, in such a manner that the user's desired account portfolio is met, as he previously input on the GUI. At step 140, account balances are taken into consideration, and online systems ensure available funds are adequate for each portion of the transaction, such that no overage will occur, and this could be done by sending credit authorizations, or other means. If any account does not have adequate capacity to meet its respective portion of the transaction (at step 140), then another iteration of the distribution algorithm is prepared at step 150, and those inadequate accounts are removed from possible accounts for targeting in the next and subsequent iterations for this specific transaction, and the step to follow that would be step 200, where we consider the possibility that not one single account of the user's has the available funds needed to meet the payment, or otherwise the capacity to hold the deposit. If no possible accounts remain (at step 200) the transaction is cancelled at step 205 and the process terminates (though if the temporary credit facility was used in a more permanent manner, it may be possible to process the transaction and this would still be in the spirit of the present invention), otherwise the remaining account or accounts are input as possible accounts for targeting in another iteration of the distribution algorithm, and the process returns to step 110, with the inadequate accounts removed from possible target outputs of the algorithm. Because a lesser number of possible accounts would require larger portions of the transaction to be routed to these remaining accounts, it brings the likelihood of finding another account that cannot handle their respective portion of the transaction during the second iteration, so if a third, or subsequent iteration is required, any inadequate accounts previously removed are not to be included as possible targets for distribution during any subsequent iterations for this specific transaction. Thus, the system and methods from step 110, leading to step 205 should be only a failsafe, as a distribution equation that includes each account's balance as a factor to the algorithm would be preferable, though should still include a credit or debit authorization at step 140 to be sure. After all targeted accounts have proven adequate for their respective portion of the transaction, and authorizations have been approved (at step 140), the system looks for user preference in regards to his temporary credit facility at step 160. If the user wishes (at step 160) for the distributed portions of the charge or deposit to be charged or deposited to the target accounts immediately, or if he does not wish to use his temporary credit facility for any reason, all payments and deposits are routed immediately, from the original account to the targeted account or accounts (to end at step 170), thus distributing some or all of the original transaction amount. If the user does wish for distribution to be settled out at the end of the period, then at step 180 a hold or credit is placed on or credited to the targeted account or accounts, as well as the original account, and the merchant can be paid by the temporary credit facility, or whatever account by which the transaction was initiated, and the user can receive his goods or services. Holds or credits placed on or credited to the accounts targeted for distribution are settled at the end of the period (step 190) (usually one day, though the settlement period can be of any length chosen by the user and agreed on by the provider of the temporary credit facility), and the next step in the process is 170. If it was an automatic payment or deposit, the payment or deposit can still be routed to the temporary credit facility, and holds or credits are placed on the targeted accounts, which will settle out the payment to repay the temporary credit facility at the end of the period, or otherwise, if it was automatic payment or deposit routed to one of the user's other accounts, holds and credits can be placed on the accounts targeted for distribution and transferred to or from them to the original account at the end of the period (a hold or credit can be placed on the original transaction account as well, to give the user access to his full availability of funds, without risking overage fees). If it was an automatic deposit it can still be paid to the temporary credit facility, and holds or credits are placed on or credited to the respective accounts as determined previously by the distribution algorithm (in the final iteration of step 110) and then distributed at step 170. If it was an automatic deposit to one of the user's other accounts, the accounts targeted by the distribution algorithm can be credited, and a hold should be placed on the original account, because funds are set be paid from this account to the targeted account, and that may cause an overage fee. At step 190, when all holds and credits are cleared, further authorizations should be sent before settling to ensure no fees are incurred by an account overage. The end of the period (step 190) triggers settlement, and all the portions of all transactions for each account in that period are aggregated into a single lump sum payment, to or from, each account to the original account or accounts, to include the temporary credit facility (though they need not be aggregated, and there are many ways settlement can occur that would still be in the spirit of the present invention) and these final payments occur in step 170, at close of the period. All of these steps except the first (step 100) can be automated in straight through processing, as per the user's preselected preference on the GUI.

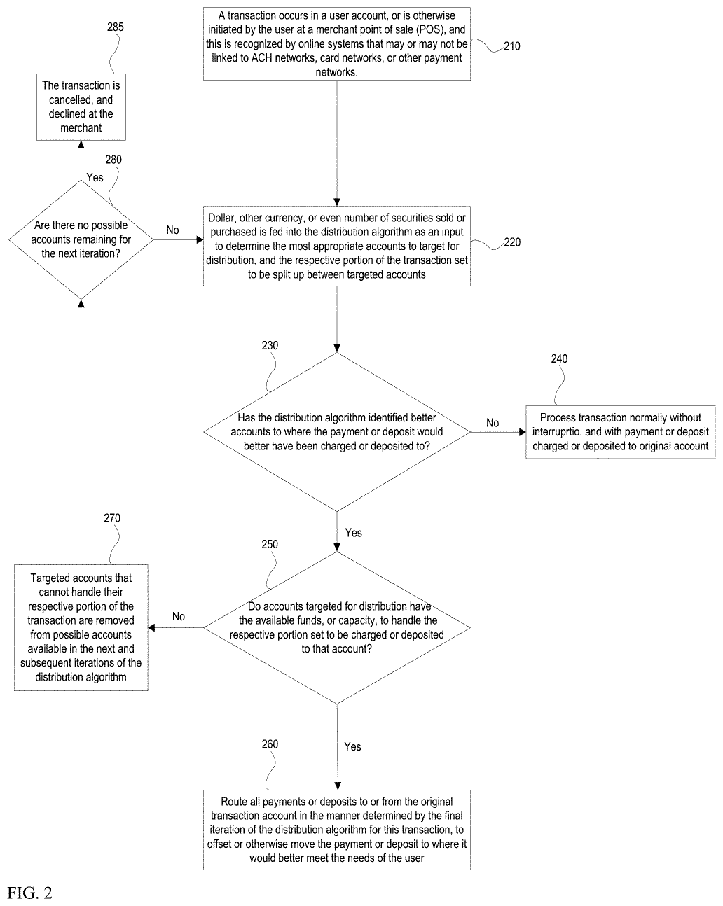

FIG. 2 is flow chart describing the possible steps to occur when methods and systems (that can be online, linked to ACH networks, card networks, EFT or other payment systems) recognize that a transaction has occurred in a user account (at step 210). At step 220 the dollar amount (or other currency amount) is fed into the distribution algorithm as an input to return a number of outputs (as in FIG. 1, though this embodiment lacks the proxy payment device, and lacks the temporary credit facility). If the distribution algorithm determined, as per the user's preselected parameters, that the original payment or deposit account was in fact the best and only account to handle that transaction (at step 230), the transaction is processed normally without interruption ending the process at step 240. Otherwise, account balances are taken into consideration at step 250. If the target accounts selected as outputs by the distribution algorithm do not have the available funds or capacity to meet their respective portion of the payment or deposit, those accounts are removed from the possible accounts that can be targeted for distribution by the distribution algorithm in step 270. If no accounts are adequate to handle the transaction, to include the original payment or deposit account, the transaction is cancelled at 285. Otherwise (at step 280), the original payment amount is fed back into the distribution algorithm (step 220), removing accounts that were inadequate to handle their respective portion of the transaction as possible outputs for the next, and any subsequent iterations of the distribution algorithm for this specific transaction. The steps from 220 leading to 285 are merely a failsafe, to ensure no overage or other fees are incurred by methods of this invention, and card authorizations should still be sent before and transactions. If all targeted accounts have the funds or capacity to meet their respective portion of the transaction at step 250, the transaction is ended at step 260, where all portions of the payment or deposits are routed to or from their targeted accounts, and to or from the original payment or deposit account, as deemed appropriate by the distribution algorithm, which is manipulated by user on the GUI.

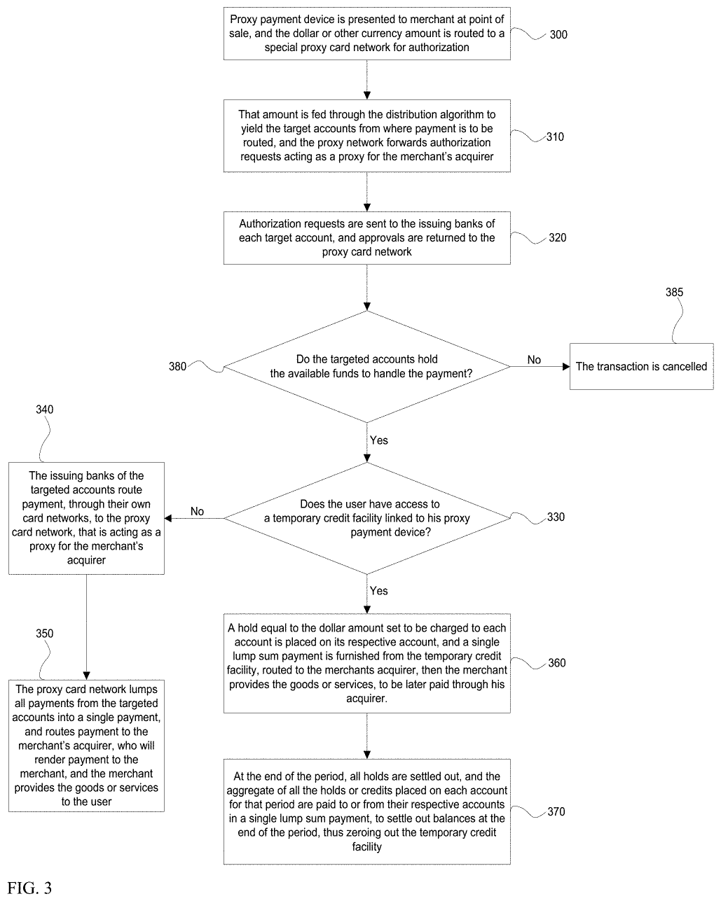

FIG. 3 is a flow chart that depicts a component method in the preferred embodiment of the present invention as described in FIG. 1, by which transactions to or from the proxy systems are authorized and processed. A transaction is initiated at step 300, when the proxy payment card or device is presented to a merchant to purchase goods or services at a POS terminal or online portal, or otherwise when an automatic payment or deposit is routed to the proxy device's account (for example: if the account numbers have been given ahead of time for an automatic payment). At step 310 the dollar amount of the transaction is fed into the distribution algorithm, to produce a number of outputs, or just a single output (or in a possible embodiment, no output at all if the temporary credit facility is decided to be more permanent). Each of these outputs corresponds to an account controlled by the user, and each output carries a dollar amount equal to a portion of the original transaction amount, as decided by the distribution algorithm, to where the transaction would best be distributed to best meet the user's desired account portfolio. The proxy account is linked to the special proxy network, which lists its own account numbers as a proxy for the merchant's acquirer when it sends off authorization requests to the issuing banks of the targeted accounts. At step 320, authorization requests for the amount of funds decided by the distribution algorithm are sent to each bank for their respective amount of that portion of the original transaction they are set to handle, and if accounts cannot meet their required portion of the transaction (at 380), inadequate accounts are removed, and the remaining can be ran back into the distribution algorithm for another iteration of targeting (as per the methods outlined in FIG. 1). If no account can be found with adequate funds or capacity to meet the payment or deposit obligation, the transaction will be cancelled at step 385, thus terminating the process. If the user does not have a temporary credit facility linked to the proxy payment device (at 330), the issuing bank of the account, or each issuing bank of the plurality of accounts, targeted by the distribution algorithm return the deposit or payment request approvals to the proxy card network, which is acting as a proxy for the merchant's acquirer, and is using the same routing numbers and account numbers (at step 340). Alternatively, this (at step 340) can be accomplished by sending the authorization requests giving the card issuer different numbers than the actual numbers of the merchant's acquirer, so that payments or deposits will be sent first to the proxy card network before further processing. At step 350, each portion of the distributed transaction is lumped together, and the proxy card network routes a single payment to the merchant's acquirer, to be forwarded to the merchant, and the transaction is completed. Otherwise, when the user does have access to a temporary credit facility, (at step 360) a hold or a credit equal to the dollar amount set to be charged or deposited to each account is placed on the respective account for the respective amount, to be cleared out at settlement at the end of the period. At settlement (step 370), the aggregate transactions that accumulated in each individual account during that period are lumped into a single payment from each individual account, to or from the temporary credit facility, or original transaction account when applicable. Another authorization request may be sent for surety against overage fees (or overpaying a credit account), and a request for payment is sent from the proxy network to the issuing bank of the user's other accounts that were chosen as targets by the distribution algorithm (this can also occur, in step 360, or any step prior or thereafter, to produce the same results, and the resulting method and system would still fall in the scope of the present invention).

FIG. 4A is a diagram that depicts a first example of a set of possible relationships among counterparts and a way in which they can be connected to facilitate automated distribution of a payment transaction, as described in steps of the previous flow charts. The user 70 has control over the distribution algorithm 78a via the GUI 75 that connects by internet, phone, or other connection 76. In this configuration, the distribution algorithm 78a is housed on the same server as software that manages the proxy card network (also 78a), and the temporary credit facility (also at 78a), and also the fault detection software that monitors all possible networks for overage fees (all included in 78a). The user 70 can present his proxy payment device 77a to a merchant 71 to purchase goods or services, and the merchant 71 would then route the payment to his acquirer 79, which would then send authorization requests to the proxy network 78a, which is acting as a proxy for the issuing bank of the user's other accounts. The proxy network 78a would then forward the authorization requests to the accounts targeted by the distribution algorithm, using bank 73a, which is the issuing bank for a credit card, and bank 73b as an example. These banks 73a, 73b would then route their respective portion of the payment to the temporary credit facility 78a, and the temporary credit facility 78a can then combine them, and route a single payment to the merchant's acquirer 79, who later pays the merchant 71, and the user 70 receives his goods or services. Though we show a system of networks as applicable to a payment, the same can occur vice versa, for a deposit or other cash inflow from the sale of goods or services, and all cash flows could occur in reverse, with cash flowing in to the user's bank or credit accounts when distributing a cash inflow to any or all of a user's accounts (to include the temporary credit facility if can be granted). These interactions can occur at any time prior to or thereafter, and settlement can occur, or be removed from the systems and methods, and there are many ways these relationships could be configured, named differently, or additional elements added, subtracted, or substituted, and the resulting system would still fall in the scope of the present invention.

FIG. 4B is a diagram that depicts a second example of a set of possible relationships among counterparts and a way in which they can be connected to facilitate automated distribution of a payment, as described in steps of the previous flow charts. A transaction originates from an account controlled by the user (bank 73a, which is the issuing bank for a credit card in this example), when payment device 77b is presented to a merchant 71 at a POS or online portal, to include a prescheduled automatic payment or draft. The merchant 71 routes the payment details to his acquirer 79, and the acquirer sends an authorization request to the user's card issuing bank 73a for the user's credit card. On authorization, the issuing bank 73a routes payment through its card network 81 to the merchant's acquirer 79, who later pays the merchant 71. Since the user 70 does not have access to a temporary credit facility to streamline distribution, the distribution algorithm would have a portion of that payment amount sent from the other bank 73b (a checking account) to the issuing bank 73a for the user's credit card to recoup a portion of that payment, thus distributing the payment amongst his accounts. The distribution algorithm 78b sends and receives information to and from the GUI 75, via internet or other connection 76 so the user 70 can manipulate parameters of the distribution algorithm, and thus controlling how funds would be distributed from 73b to 73a. Though we show a system of networks as applicable to a payment, the same can occur vice versa, for a deposit or other cash inflow, and all cash flows could occur in reverse, with cash flowing in to the user's bank or credit accounts when distributing a cash inflow to any or all of a user's accounts (to include the temporary credit facility if it can be granted). These interactions can occur at any time prior to or thereafter, and settlement can occur, or be removed from the systems and methods, and there are many ways these relationships could be configured, named differently, or additional elements added, subtracted, or substituted, and the resulting system would still fall in the scope of the present invention.

FIG. 4C is a diagram that depicts a third example of a possible embodiment of the present invention to facilitate payment, illustrating a system of networks built in accordance with principles of one embodiment of the present invention, which shows the possible relationships between elements described in steps of the previous flow charts. A transaction originates from the special proxy payment device 77a, when the user 70 presents it to a merchant 71 for payment for goods or services, to include a prescheduled automatic payment. The merchant 71 routes the payment details to his acquirer 79, and the acquirer sends an authorization request to the special proxy network 78c. The authorization requests will be forwarded to the issuing banks of the user's other accounts (73a, which can represent a checking account, and 73b, which can represent a credit card account), in a manner determined by the distribution algorithm (also at 78c), so that each of his other accounts is to handle a portion of the original payment. The distribution algorithm 78c can be manipulated by the user 70 by the GUI 75 through an internet or other connection 76 which connects to the algorithm at 78c. In this configuration, settlement periods need not be implemented, as the user has not been granted a temporary credit facility, further, the card issuing banks 73a, 73b immediately route payment through their card networks (not shown) to pay the merchant's acquirer 79 on the spot, who later pays the merchant 71, thus he provides the user with his goods or services. These interactions can occur at any time prior or thereafter, and settlement periods can possibly be implemented in this configuration, and there are many ways these relationships could be configured, named differently, or additional elements added, subtracted, or substituted, and the resulting system would still fall in the scope of the present invention.

FIG. 4D is a diagram that depicts a fourth example of a possible embodiment of the present invention to facilitate payment, depicting a system of networks constructed in the spirit of the present invention that further illustrates the relationships between elements referred to in the previously discussed flow charts. A transaction originates when the user 70 presents his special proxy payment device 77a to a merchant 71 for payment for goods or services, to include a prescheduled automatic payment or draft. The merchant routes the payment details to his acquirer 79, and the acquirer sends an authorization request to the special proxy card network 78d. In this example, the distribution software is co-located on the same hardware as the proxy network (all at 78d), and the dollar amount of the transaction is fed into the distribution algorithm to yield the targeted accounts, each to handle a portion of the original payment. The proxy card network forwards an authorization request to the issuing bank of the user's debit card 73a, and that account routes payment through its card network (not shown) to the merchant's acquirer 79, which pays the merchant 71, who provides the user his goods or services. Further, an authorization request is sent to the other account (73b, which can represent a credit card) targeted by the distribution algorithm, and the issuing bank of the credit card routes payment through its own card network to pay a portion of the original payment amount to the first account (the debit account at bank 73a), thus distributing the payment amount between the two accounts. Parameters of the distribution algorithm at 78d, can be controlled by the GUI 75, via an internet or other connection 76. In this possible embodiment, the distribution algorithm is located on the same hardware as the proxy card network (both at 78d), but it can also be located on the same hardware as the GUI (75 in this example), as will be shown in FIG. 4E. These interactions can occur at any time prior or thereafter, and settlement periods can possibly be implemented in this configuration (though they need not be), and there are many ways these relationships could be configured, named differently, or additional elements added, subtracted, or substituted, and the resulting system would still fall in the scope of the present invention.

FIG. 4E is a diagram that depicts a fifth example of a possible embodiment of the present invention to facilitate payment, illustrating a system of networks constructed in the spirit of the present invention that further illustrates the relationships between elements referred to in the previously discussed flow charts. A transaction originates when the user 70 presents a card or other payment device 77b to a merchant 71 at a POS for payment for goods or services, to include a prescheduled automatic payment or draft, or a payment made at an online portal. The merchant routes the payment details to his acquirer 79, and the acquirer sends an authorization request to the issuing bank of the user's payment device 73a (which can represent a debit checking account). The bank 73a then routes payment through its card network 81 to the merchant's acquirer 79, which later pays the merchant 71, thus the merchant provides the user his goods or services. Online systems that can monitor EFT networks, card networks, ACH networks, or any other online payment systems will recognize that a transaction has occurred in a user account, thus triggering distribution. In this example, the distribution software is co-located on the same hardware as the proxy network and account monitoring software (all at 78e) as well as the GUI 75, be it on a company's own private server, a desktop computer, or even a mobile device, thus an internet or other connection would not be needed between the GUI 75, and distribution algorithm 78e, as it could be manipulated directly by Ethernet or virtual connection if housed on the exact same hardware. The dollar amount of the transaction is fed through the distribution algorithm 78e, to yield the targeted accounts, each to handle a portion of the original payment, to include the original payment account as a possible target. In this example, the distribution algorithm decided that the payment would best have been divided between the original payment debit account 73a, and his credit card account 73b; as the full payment has already been made from the debit account 73a, an authorization request is sent to the user's credit card account 73b, to make payment to debit account 73a, then the credit account routes payment through its card network (not shown) to the original payment account 73a, thus distributing payment between the two accounts. These interactions can occur at any time prior to or thereafter, and settlement periods can possibly be implemented in this configuration (though they need not be), and there are many ways these relationships could be configured, named differently, or additional elements added, subtracted, or substituted, and the resulting system would still fall in the scope of the present invention.

FIG. 4F is a diagram to summarize relationships between the possible proxy elements which can be implemented, the user interface 75, the proxy network and/or temporary credit facility software 78a, 78b, 78c, 78d, 78e, 78g, 78h, the merchant 79, and the proxy payment device 77a. The distribution algorithm can be housed in the same hardware as other components, and can communicate via internet or other connection if the GUI 75 was not also housed in the same hardware. The proxy network and/or temporary credit facility software 78a, 78b, 78c, 78d, 78e, 78g, 78h would communicate with the merchant via electronic signals over some type of payment network, and this would occur when the user presents the proxy payment device 77a to the merchant at a POS or online payment portal.

FIG. 4G is a diagram that depicts a first example of a set of possible relationships among counterparts and a way in which they can be connected to facilitate automated distribution of a deposit transaction or other cash inflow, as described in steps of the previous flow charts. A transaction originates when a deposit or other cash inflow 83 is routed to the temporary credit facility 78g. The dollar (or other currency, or even number of shares of a security or shares of a fund) is fed into the distribution algorithm (also at 78g) as an input to yield the targeted accounts to where the deposit would best be deposited to and the respective amount for each account, which is a portion of the original deposit set to be forwarded to each account. The distribution algorithm 78g can be manipulated by the user by his GUI 75, which communicates with the distribution algorithm via internet, phone line, or other connection 75, or can even be housed on the same hardware as the distribution algorithm, and written into the same software program as other systems of the invention, or be its own software program connected by Ethernet or a virtual connection. The accounts targeted for distribution are represented by 73a, 73b, and 73c which can be any mixture of credit or demand deposit accounts; if an account is a credit account, some type of authorization, or other measure of checking if the deposit will overpay a credit account should be sent. In this embodiment, which is a preferred embodiment, settlement periods can be implemented, and these interactions can occur at any time prior or thereafter, and settlement periods can also be removed from the system, and there are many ways these relationships could be configured, named differently, or additional elements added, subtracted, or substituted for like elements that perform essentially the same task, and the resulting system would still fall in the scope of the present invention.

FIG. 4H is a diagram that depicts a second example of a set of possible relationships among counterparts and a way in which they can be connected to facilitate automated distribution of a deposit transaction or other cash inflow, as described in steps of the previous flow charts. A transaction originates when a deposit or other cash inflow 83 is routed to a user's account 73a (which can represent a checking account). Online systems that can monitor EFT networks, card networks, ACH networks, or any other online payment systems will recognize that a transaction has occurred in a user account, thus triggering distribution. The dollar (or other currency) amount is fed into the distribution algorithm (also at 78h) as an input to yield the targeted accounts to where the deposit would better have been deposited to, and the respective amount for each account, which is a portion of the original deposit set to be forwarded from the original deposit account to the other accounts (73b, 73c). The distribution algorithm 78h can be manipulated by the user by his GUI 75, which communicates with the distribution algorithm 78h via internet, phone line, or other connection 76, or can even be housed on the same hardware as the GUI, written into the same software program as other systems of the invention, or its own software program connected by Ethernet or a virtual connection. The accounts targeted for distribution 73b, 73c, and to include the original account 73a (which could be a possible targeted account for an output of the distribution algorithm to hold a portion of the deposit), can be any mixture of credit card or demand deposit accounts; if an account is a credit account, some type of authorization, or other measure of checking if the deposit will overpay a credit account should be sent before distribution. In this embodiment settlement periods need not be implemented, and so immediately, funds are transferred from the original deposit account 73a, to the other targeted accounts 73b, 73c, though because in this example the original deposit account 73a was decided to be a target, some of the original deposit is allowed to stay in that account, at an amount decided by the distribution algorithm. Thus, the deposit has been distributed between the user's total accounts automatically and in the manner that best meets his credit and savings needs. These interactions can occur at any time prior or thereafter, and settlement periods can also be removed from the system, and there are many ways these relationships could be configured, named differently, or additional elements added, subtracted, or substituted for like elements, and the resulting system would still fall in the scope of the present invention.

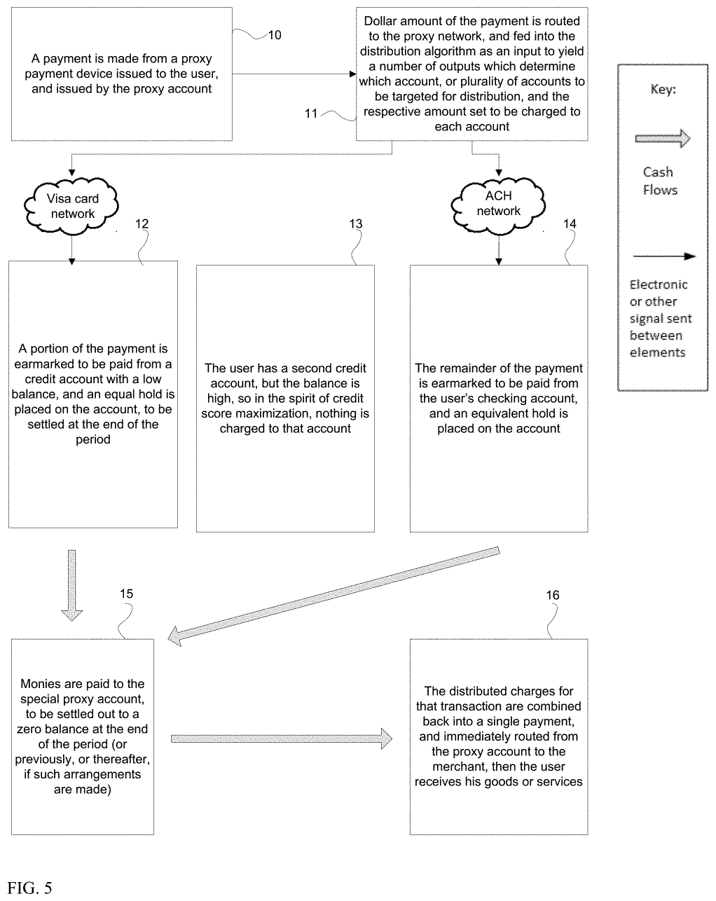

FIG. 5 is a block diagram depicting a first example of the methods by which a payment transaction can be distributed to better meet the user's credit and savings goals. In this example in which a payment is processed according to a preferred embodiment, the user has been issued a proxy payment device, and has access to a temporary credit facility, as well as three other possible accounts by which a transaction could be paid for: two credit card accounts, and a checking account. The user has selected the option that transactions be distributed amongst accounts in a manner most favorable to his credit score (this is chosen via the GUI which controls variables in the math formulas of the distribution algorithm). First, a payment is made or otherwise initiated at step 10, and is charged to the user's temporary credit facility, to be zeroed out later at settlement at the end of the period (or possibly some later date). Any payment to or from this account triggers the next step 11. At 11, the exact dollar amount of the total payment is fed into the distribution algorithm as an input, to produce a number of outputs that determine a portion of the payment set to be charged to each account targeted by the distribution algorithm. A portion of the payment is earmarked to be paid from a credit account 12 to the temporary credit facility, and this can be done immediately or at the end of the period to settle out some or all of the charge incurred to the temporary credit facility (this is also done according to user preference, as selected on the GUI, and can also be done at some later date, earlier in the process, or in any other manner and still fall in the scope of the present invention). None of the payment is set to be charged to the user's second credit account 13, as it is near its credit limit, and a charge to this account would be detrimental to the user's credit score as per FICO or other major credit scoring formulas. In the spirit of credit score benefits, the remainder of the payment that was not charged to the user's credit accounts is earmarked to be charged to his checking account 14 and paid to the temporary credit facility, either immediately or at settlement at the end of the period (this will bring the temporary credit facility account to a zero balance, however, as said previously, the charges can be settled at a later date, or this can occur at any other step, and other steps could be added or removed to yield the same benefit, and any changes to the sequence of steps in this process would remain in the spirit of the present invention, as described herein). In this example monies are paid from the credit account and the checking account to the temporary credit facility 15, where holds or credits are placed or credited as a marker on the credit and checking accounts, to later be settled out at the end of the period. After monies are paid to the temporary credit facility (at 15), the split payments are combined back into a single payment, and paid to the merchant immediately 16, then the user can receive his goods or services. As a further example, popular credit scoring methods deem that 25 percent of an account's available credit is a level that shows a credit user is credit worthy in making credit decisions and reflects positively in scoring formulas, thus the distribution algorithm in such examples seeks to utilize 25 percent of each accounts available credit in each credit account targeted for possible accounts to handle a charge, and will route charges to those credit accounts if they are below that level. And as another further example, were this a deposit transaction, the distribution algorithm could use a portion of a deposit to pay down a credit card to bring it closer the 25 percent level which popular credit scoring methods deem representative of credit worthiness, if it were currently above that level.

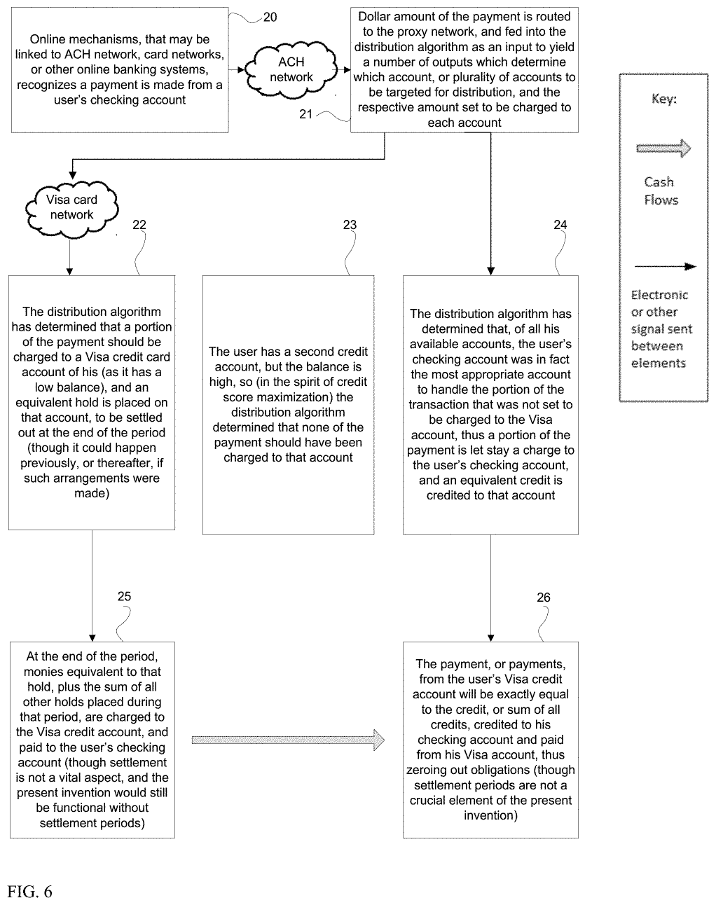

FIG. 6 is a block diagram depicting a second example of the methods by which a payment transaction can be distributed to better meet the user's credit and savings goals, according to one embodiment of the present invention. In this example of a transaction processed in accordance with one embodiment of the present invention, the user has not been issued a proxy payment device, and has no access to a temporary credit facility. He has three possible accounts from which a transaction could be paid for: two credit card accounts, and a checking account. The user has selected the option that transactions be distributed amongst accounts in a manner most favorable to his credit score, via the GUI. First, a payment is made or otherwise initiated at step 20, and paid from his checking account. The dollar amount is fed into the distribution algorithm as in input at 21, to produce a number of outputs for which accounts to be targeted by the distribution algorithm, chosen from amongst his total available accounts, to include the original checking account which the payment was initially charged to; the accounts chosen for distribution are his visa credit card, and the checking account from which the payment was originally charged to. At 22, a hold is placed on the Visa credit account targeted by the distribution algorithm, equivalent to a portion of the original payment amount, as determined by the distribution algorithm, to be charged to that account at settlement at the end of the period, and paid to the checking account, to which the payment was originally charged to (or this can be done immediately, or at any other date, or even done at a previous step in the process, and remain in the spirit of systems and methods of the present invention, as outlined herein). None of the payment is set to be charged to the user's second credit account 23, as it is near its credit limit, and a charge to this account would be detrimental to the user's credit score as per FICO or other major credit scoring formulas. In the spirit of credit score benefits, the remainder of the payment that was not charged to the user's credit accounts is let stay as a charge to his checking account 24, albeit partially offset by a payment from the first credit account. At the end of the period 25 monies equivalent to that hold, plus the sum of all other holds placed during that period are charged to the Visa credit account, and lumped into a single payment paid to the original payment account, thus settling out all holds and credits at 26. These interactions can occur at any time prior or thereafter, and settlement periods can also be removed from the system, and there are many ways these relationships could be configured, named differently, or additional elements added, subtracted, or substituted for like elements, and the resulting system would still fall in the scope of the present invention.

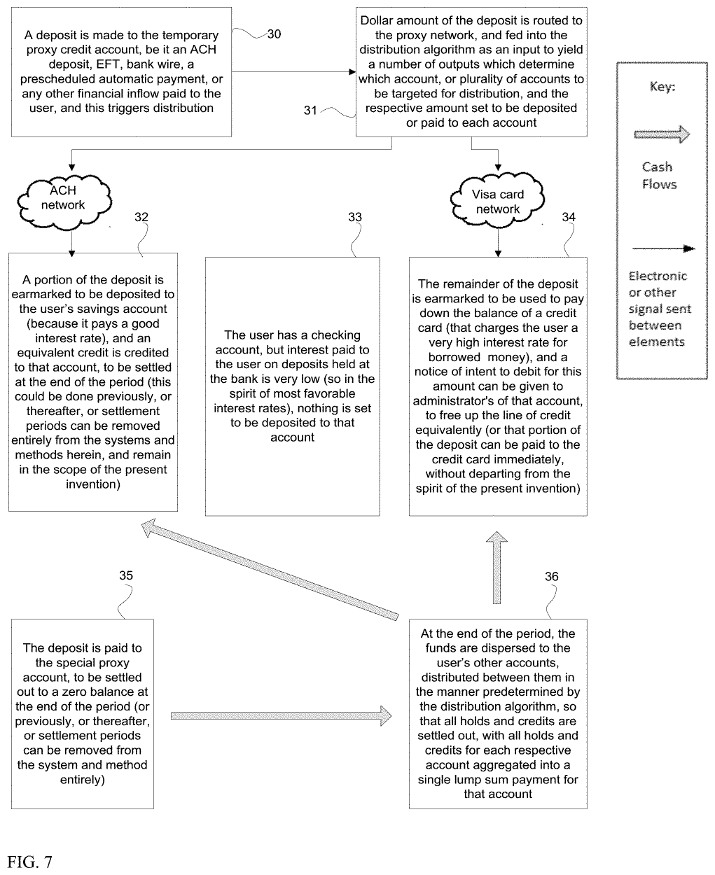

FIG. 7 is a block diagram depicting a first example of the methods by which a deposit transaction can be distributed to better meet the user's credit and savings goals. In this example of a preferred embodiment of the present invention, the user has been issued a proxy payment device, and has access to a temporary credit facility (which here we shall refer to as a proxy account, as here it will be used to hold funds, and not to provide credit), as well as three other possible accounts to which a deposit or other cash inflow could be deposited or paid to: a savings account, a credit card account, and a checking account. The user has selected the option that transactions be distributed amongst accounts in a manner most favorable to interest rate gains or charges via the GUI. First, a deposit is made or otherwise prescheduled at step 30, and is deposited to the user's proxy account (temporary credit facility), to be zeroed out at settlement at the end of the period (or possibly some later date). Any deposit to this account triggers the next step 31. At 31, the exact dollar amount of the total deposit is fed into the distribution algorithm as an input, to produce a number of outputs that determine the targeted accounts to which the deposit shall be deposited or paid to. Each account targeted by the distribution algorithm is set to receive portions of the original deposit, the sum of which is exactly equal to the original deposit amount. A portion of the deposit is earmarked to be deposited to the user's savings account 32, which pays a high interest rate to the user, and that account can be credited with a guarantee of later payment. None of the deposit is set to be deposited to the user's checking account (at 33), which pays a low interest rate to the user, as the user has selected interest rate concerns as his primary objective. In the spirit of interest rate benefits, the remainder of the deposit that was not earmarked to the user's other accounts is earmarked to be paid to his credit card account 34 to pay down the balance, on which the credit card charges the user a high interest on the balance, and this can occur either immediately or that account can be credited with a guarantee of later payment at settlement at the end of the period. Thus, the original deposit is let stay in the proxy account (temporary credit facility) 35, and distribution of these funds to the targeted accounts at settlement 36 will bring the temporary proxy account to a zero balance (however, as said previously, the holds and credits can be settled at some later date beyond the set period, or this can occur at any step, previously or thereafter, and any changes to the sequence of steps in this process would remain in the spirit of the present invention, as described herein). Said otherwise, at the end of the period 36 an amount equal to the earmarks is paid to settle out the balance in the temporary proxy account with all the earmarks aggregated into a single lump sum payment to and from each account to the temporary credit facility (this is also done according to user preference, as selected on the GUI, and can also be done at some later date, at some other step in the process, or in any other manner and still fall in the scope of the present invention).

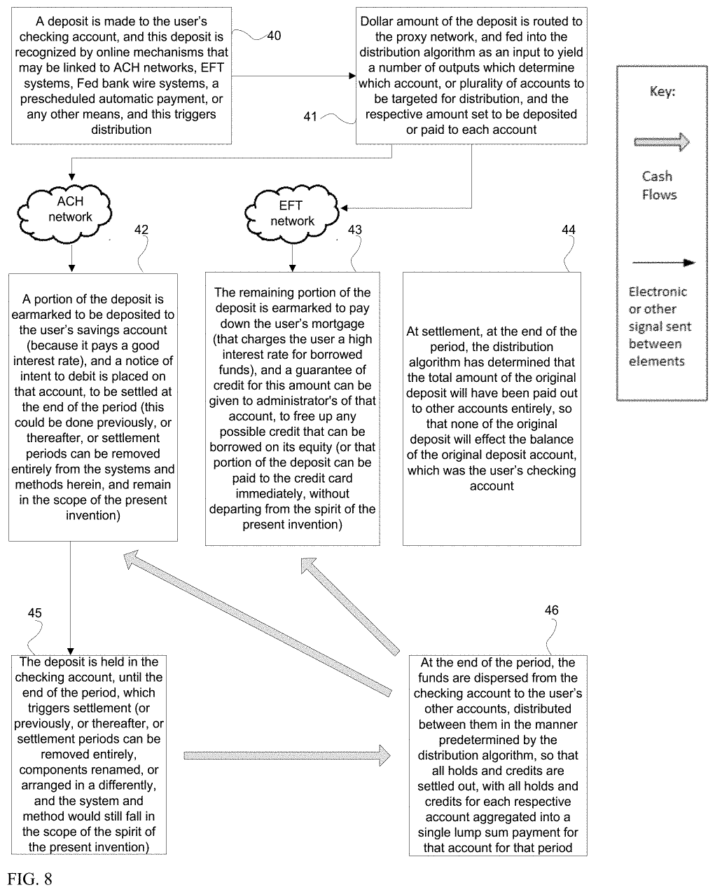

FIG. 8 is a block diagram depicting a second example of the methods by which a deposit transaction can be distributed to better meet the user's credit and savings goals, processed in accordance with one embodiment of the present invention. The deposit can be distributed amongst the user's total available accounts to better meet the user's credit and savings goals. In this example, the user has not been issued a proxy payment device, and does not have access to a temporary credit facility. He has three available accounts to which a transaction could be deposited or paid to: a savings account, a mortgage account, and a checking account. The user has selected the option that transactions be distributed amongst accounts in a manner most favorable to interest rate gains or charges, via the GUI. First, a deposit is made or otherwise prescheduled at step 40, and is deposited to the user's checking account, to be forwarded to other accounts at settlement at the end of the period (alternatively, this can occur immediately, or possibly some later date). Any deposit to this account triggers the next step 41, recognized via online or other payment network monitoring systems. At 41, the exact dollar amount of the total deposit is fed into the distribution algorithm as an input, to produce a number of outputs that determine a portion or portions of the original deposit amount set to be transferred or paid to another account or accounts targeted by the distribution algorithm, and the original deposit account can be a possible target as well, even though no funds would need to be transferred in such a case. A portion of the deposit is earmarked to be forwarded to the user's savings account 42, which pays a high interest rate to the user, higher than that of the original deposit account. In the spirit of interest rate benefits, the remainder of the deposit that was not earmarked to the user's savings accounts is earmarked to be paid to his mortgage account 43, to pay down the balance, on which the mortgage provider charges the user a high interest rate on the balance, and this can occur either immediately or at settlement at the end of the period. None of the deposit is set to remain in the user's checking account 44, which pays a low interest rate to the user, as the user has selected interest rate concerns as his primary objective, thus none of the deposit is set to remain in the original deposit account after settlement at the end of the period. Thus, the original deposit amount is held in the original deposit account until the end of the period 45, which triggers settlement (at 46), and the funds are then distributed to the targeted accounts (being the savings account and mortgage account mentioned at 42, 43) and none of the original deposit amount is left in the original deposit account after settlement (this can be done immediately, or some later date, or even done at some earlier step in the process, and further, this is done according to user preference, as selected on the GUI, and can also be done at some later date, at some other step in the process, or in any other manner, and still fall in the scope of the present invention, but as per this specific embodiment, as described here, payment is forwarded at the end of the period).

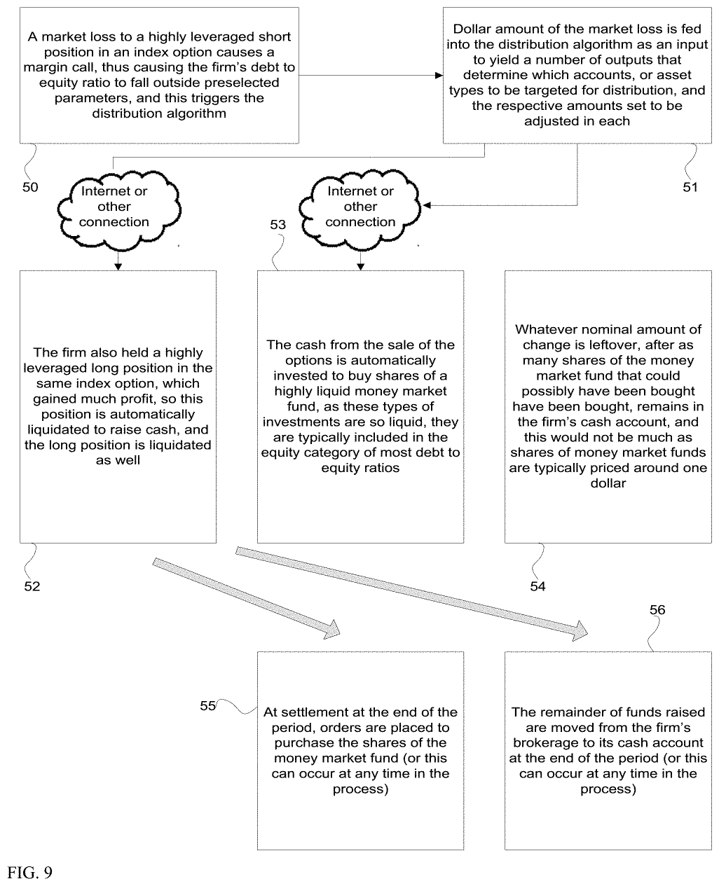

FIG. 9 is a block diagram depicting an example of the methods by which the present invention can be applied to a corporate setting, processed in accordance with one embodiment of the present invention to automatically meet the using corporation's desired credit and savings portfolio. The corporation's finance manager has selected the option that transactions be distributed in the manner most favorable to credit rating concerns. In this example, the using firm owns a highly leveraged short position in an index-based option, and the market has moved against it, thus causing the firm's debt to equity ratio to fall outside of preselected parameters, which triggers the automated distribution algorithm. At 50 the dollar amount of the market loss is fed into the distribution algorithm as an input, to yield a number of outputs that determine which account types, or asset classes or types to be targeted for distribution at 51, causing the following automated responses (as preselected by the finance manager by the GUI): the firm liquidates its position in the index option by an automatic market order on the open market, thus generating cash (which is included in the equity side of debt to equity ratios); the firm also held a highly leveraged long position in the same index option, and this position is automatically liquidated as well, to further raise cash (at 52); as per firm preference (chosen on the GUI), cash from the sale of the options is set to be invested to buy shares of a money market fund at 53 at the end of the period, as such funds are highly liquid, and often included in the equity category of calculation of debt to equity ratios (and in addition to that, this option was chosen because the fund generates a rate of interest as opposed to leaving the cash proceeds from the options sales un-invested, and this is to be included in this example so as to illustrate the possibility of multiple concerns that can be programmed into the GUI with tiers of importance, so that once a first concern has been met, automated transactions can then meet the user's second concern, and so on and so forth). Whatever nominal amount of change is leftover, after as many shares of the money market fund as could have possibly been bought have been bought, will remain in the firm's cash account (at 54), which would not be much as shares of such funds are typically priced around one dollar. At settlement at the end of the period 55 all orders are placed to purchase shares of the money market fund (alternatively, this can occur immediately, or possibly some later date). The remainder of funds raised from the sale of the options is moved from the firm's brokerage account to its cash account after 56. Any deposit to this account triggers the next step 41, recognized via online or other payment network monitoring systems. These interactions and steps in the processing can be done immediately, or some later date, or even done at some earlier step in the process, and further, this is done according to user preference, as selected on the GUI, and can also be done at some later date, at some other step in the process, or in any other manner, and still fall in the scope of the present invention.

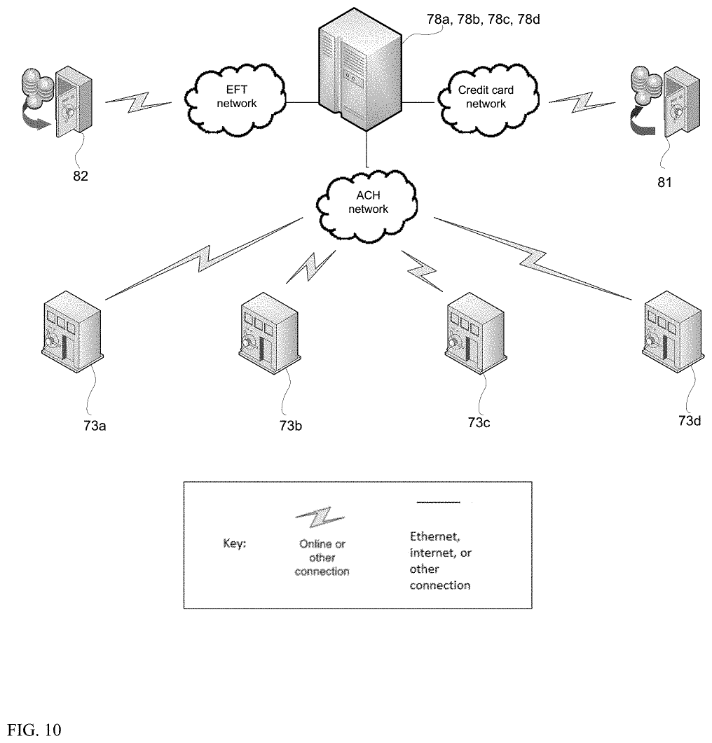

FIG. 10 is a diagram that depicts a possible network configuration for account monitoring against overage or other fees, built in accordance with principles of the present invention. Relationships between online systems that monitor card networks, ACH networks, EFT networks, or other interconnected payment systems are shown. The proxy network and/or temporary credit facility software 78a, 78b, 78c, 78d, 78e, 78g, 78h, which includes the distribution algorithm software (in this example) can be connected to EFT networks, ACH networks, and credit card networks, as well as any other online payment systems. Connections to EFT networks can facilitate the monitoring of the electronic funds transfers to or from checking or savings accounts 82. Connections to credit or other card networks 81 can monitor for credit account transactions, and overage assurance. Connections to ACH networks, or online banking portals can facilitate the protection of the user's bank account (represented by 73a, 73b, 73c, and 73d, which can represent any account type, to include the issuing bank's for the user's credit cards), and these connections can be internet, Ethernet, phone lines, or any combination of these, or any type of communication link, to include wireless. These systems and networks can be configured in any way, and additional elements can be added, subtracted, renamed, or substituted to yield the same benefit, and the resulting systems would still fall in the scope of the present invention. Further, such mechanisms need not be claimed as they are implicit in the systems and methods of the invention as claimed herein.

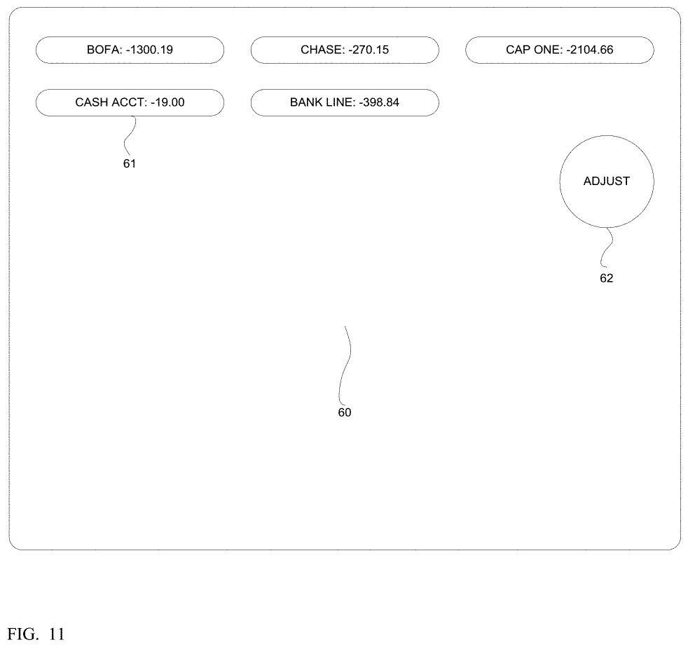

FIG. 11 depicts a sample screen of a possible display for the graphical user interface (GUI). What is depicted at 60 can be either the screen of a computer monitor, or the upper half of a user's mobile device. When a transaction occurs, a ribbon 61 can appear at the very top of the screen, which displays the dollar amount of the transaction sent to each account, done post distribution, or otherwise earmarked for later distribution. An icon 62 could appear along with it, allowing the user to alter distribution parameters, and selecting that icon 62, will open a menu of the options to alter parameters, or further alter the amounts by which that specific transaction was divided up between accounts. One possible way of displaying the amounts charged to or deposited to each account: negative items written in red, and positive items in black or green, however any possible color can be used, and possibly, a sign, be it a plus or minus, can be used to convey charges or deposits to each account, however any possible means of conveying information regarding the distribution algorithm would still be in the spirit of the present invention. This ribbon can be swiped away, or otherwise dismissed from the screen, and there are several possible ways the GUI can notify the user of charged or deposited transactions, and any means of displaying this information would still be in the spirit of the present invention. Apart from this notification ribbon, there could be an icon to open menus to alter the methods by which the invention operates, and further, a more permanent widget can be affixed to the screen to alter the distribution algorithm on the fly. An onscreen icon on the user's home screen can also be included There are many ways by which mechanisms of the invention could be accessed, and no change to the ways by which information regarding the invention is displayed or input should be construed as a change to the ideas of the invention, and should still fall in the scope of what the invention seeks to accomplish.

It should be understood that the foregoing embodiments are merely exemplary of the present invention and that alternative embodiments are still within the scope of the present invention. For example, any number and type of accounts, distribution algorithms, or severs that house the distribution engine can be used, be they centralized on a single server, or decentralized on another server or any number of servers, to provide the functionality described herein, and any type of communication links and protocols can be used, and be communicated with by any number and type of portal or portals, web connections, or inputs to a program housed on the same server as the invention's mechanisms. Moreover, various aspects of each embodiment can be combined, altered, substituted, or otherwise omitted and removed from network configurations as described in the examples provided, and the steps described to achieve the end result can be performed in any sequence to still achieve the results of the present invention, and this would still be in the spirit of the invention as described herein. It should also be noted that informations regarding the user's selections can be provided to managers of the invention's proxy account and payment systems, and this would be a component of the preferred embodiment of present invention. This would be particularly useful, as it would permit a means for these managers to better satisfy the needs of both the user, and their own interest in management of the invention's proxy account and payment systems and methods.

While there have been shown, described, and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, temporary charges and deposits need not be held in any account at all, and can be securitized in a type of highly liquid short term publicly traded security, or can possibly be issued as commercial paper or any other means of marking the debt or deposit which has not yet been satisfied, or these credit and debit items can be merely an IOU said between the user and other entities involved in the systems and methods of the invention. Further, it is expressly intended that all combinations or substitutions of those elements which perform substantially the same function in substantially the same way to achieve the same result are within the scope of the invention. It is the intention, therefore, to be limited only as indicated by the scope of the claims appended hereto.

I claim:

1. A method that provides for automating a user's credit and savings decisions by distributing them between a plurality of accounts in a preselected manner, distributed between all accounts that are available to the user, that method comprising:
receiving a signal from remote or local networks that monitor each of a user's available accounts, that can be linked to ACH payment networks, EFT networks, debit and credit card networks, or other online payment systems such as online banking portals;
said signal triggers a mathematical algorithm that distributes the total currency amount of any payment or deposit transaction that occurs, or is initiated by that user, and is distributed between all the user's available accounts, to include the account in which the original transaction occurred when applicable, whenever a payment or deposit occurs in any user account;
said mathematical algorithm is programmed into software installed on hardware that determines how a payment or deposit may be distributed between a user's available accounts to best meet that user's desired portfolio of account balances; and
said remote or local network communicates with ACH payment networks, EFT networks, debit and credit card networks, or other online payment systems to move funds between accounts in the manner decided by said distribution algorithm.

2. The method of claim 1 wherein the distribution software is located on one of hardware housed on a remote central server connected by online networks phone networks or other means of communication, housed on any number of decentralized servers connected by online networks, phone networks or other means of communication, or housed on a local server directly controlled by the user.

3. The method of claim 1 comprising a graphical user interface to manipulate variables in the mathematical formula, such that the user of the invention, or other person, can modify parameters of the distribution, and possible parameters of the distribution can be one, or any combination, of:
distributing transactions in the manner most favorable to the user's credit score or rating;
distributing transactions in the manner most favorable to interest rates charged to or paid to the user;
distributing transactions in a manner such that all transactions are charged to available credit and cash is raised in deposit accounts;
distributing transactions in a manner such that deposit are used to pay down the balances of credit accounts and available credit is raised in the user's accounts;
distributing transactions in a user customized manner such that transactions are distributed to meet any specific concern of the user to include all payments are charged only to a single account;
distributing transactions such that account balances are all kept at proportionately equal levels in concern to credit to cash balances; or
distributing transactions according to any combination of that described above, with the priority of each concern also chosen in any customized manner such that transactions are distributed to meet any specific concern of the user.

4. The method of claim 1 wherein fund transfers, as decided by the distribution algorithm, are not executed until the end of a set period, which can be any length of time.

5. The method of claim 1 comprising a temporary credit facility, issued by some entity, which facilitates the distribution of payment or deposit transactions by acting as a store of credit for payment until the transaction is finally distributed and charged to the user's other accounts, or otherwise, as a store of value until a deposit is finally distributed and deposited to the user's other accounts, which can occur immediately, at the end of the period as described by claim 4, or at any other time.

6. The method of claim 1 comprising a special proxy card network for routing payment or deposit transactions either to the temporary credit facility, or to any account or accounts chosen by the distribution algorithm to include a single preselected account or plurality of accounts as chosen by the user.

7. The method of claim 1 comprising a special proxy payment device issued by either administrators of the invention's systems or issued by the administrators of the temporary credit facility, and said payment device can route payment or deposit transactions to the temporary credit facility described by claim 5 or to the special proxy card network described by claim 6 for further distribution of a deposit or payment transaction to or from a preselected account or accounts.

8. A method that provides for the automated distribution of a payment or deposit transaction, distributed between any or all of a user's accounts in a preselected manner, and that method comprising:
a special proxy payment device, with card numbers and routing numbers, such that it acts as a proxy for the issuing bank of either the temporary credit facility or the issuing bank of any and all other accounts controlled by the user, or as a proxy for some other financial entity be it real or non-existing;
a special proxy card network that can either route a deposit to another account or split between two or more accounts controlled by the user, or that routes credit and debit authorization requests to the issuing banks of a user's accounts, using its own routing numbers as a proxy for that of the merchant's acquirer so that authorization approvals are returned to the proxy card network after the requests have first been forwarded to the issuing banks of accounts chosen for distribution of a transaction;
receiving approval of the authorization requests that had been sent to the accounts chosen for distribution, said proxy network can forward a single approval to the merchant's acquirer; and
said proxy card network can route a single payment to the merchant's acquirer for payment, and the proxy network will receive an equal payment through the actual card network or card networks of the account or accounts chosen for distribution of that payment transaction.

9. A method that provides for the automated distribution of a deposit transaction or other cash inflow, distributed between any or all of a user's accounts in a preselected manner, and that method comprising:
a special proxy payment device, with card numbers and routing numbers, such that it acts as a proxy for the issuing bank of either the temporary credit facility or the issuing bank of any and all other accounts controlled by the user, or as a proxy for some other financial entity be it real or non-existing;
a special proxy card network to which deposits can be routed for distribution to the issuing banks of the account or accounts chosen by the distribution algorithm, be them credit card accounts or deposit accounts; and
said proxy card network can hold the funds in the temporary credit facility before distribution at the end of a set period, or route them straight through to be distributed immediately to the chosen bank account or bank accounts or credit card account or accounts when applicable.

10. The method of claim 1 comprising network connections wherein all of a user's accounts are monitored around the clock to protect against the adverse effect of any fee or charge to an account which may occur outside the scope of systems and methods of the present invention, that method comprising:
online networks that monitor ACH networks, EFT networks, credit card networks, online banking portals, or other online payment systems, monitoring for fees, or transactions that would place an account below zero or minimum level, or otherwise a credit account over limit or over pay it, thus triggering a signal to mechanisms that transfer funds, such as the special proxy card network, or ACH transactions, EFT transactions, or any other means of transferring funds between account; and
on receipt of the signal, funds will be transferred between accounts to protect from the fee or overage, and this can also be done in accordance with the distribution algorithm, or some other manner that can be preselected by the user.

11. A system that provides for automating a user's credit and savings decisions by distributing payment and deposit transactions between any or all of a user's available accounts, that system comprising:
hardware that houses software containing a mathematical algorithm for distributing a payment or deposit transaction amongst any or all of a user's available accounts on receipt of a signal from other components of the invention;
a network interface that communicates with ACH networks, EFT networks, debit and credit card networks, online banking portals, and other payment systems which recognize when a transaction has occurred in a user account, triggering a signal to be sent to the distribution software component of the invention;
an interface for communication with the distribution software, be it internet, phone line, or a virtual connection if the interface software is housed on the same hardware as the distribution software; and
a network interface that communicates with ACH networks, EFT networks, debit and credit card networks, online banking portals, and other payment systems that can initiate payment and fund transfer transactions between user accounts, to and from merchants at a merchant POS, and to and from banks, credit card accounts, brokerage accounts, or other financial entities that may pay monies to the user.

12. The system of claim 11 wherein the distribution software is located on one of hardware housed on a remote central server connected by online networks phone networks or other means of communication, housed on any number of decentralized servers connected by online networks, phone networks or other means of communication, or housed on a local server controlled by the user.

13. The system of claim 11 comprising a graphical user interface that manipulates variables in the mathematical distribution formula, such that the user can modify parameters of the distribution, and said graphical user interface can be software housed on the same server as the distribution software, or can be housed on hardware controlled by the user or other person such as on a mobile device, a desktop PC, or a corporation's own private server, and be connected to hardware that houses the distribution software by online networks, phone networks, or other means of communication.

14. The system of claim 11 comprising a temporary credit facility, issued by a bank or other financial entity, which facilitates the distribution of payment or deposit transactions by acting as a store of credit for payment until the transaction is finally distributed and charged to the user's other accounts, or otherwise, as a store of value until a deposit is finally distributed and deposited to the user's other accounts, and is done in accordance with the methods described by claim 8.

15. The system of claim 14 wherein the software which manages said temporary credit facility can be one of:
housed locally on the same hardware which houses another component of the invention;
housed remote at the financial entity which issued the credit and communicate with other components of the invention and payment systems by online networks, phone networks, or some other form of communication;
housed remote on the same hardware which houses another component of the invention and communicate with other components of the invention and payment systems by online networks, phone networks, or some other form of communication; or
housed on its own remote server and communicates with other components of the invention and payment systems by online networks, phone networks, or other form of communication.

16. The system of claim 11 comprising a special proxy card network for routing payment or deposit transactions either to the temporary credit facility, or to any account or split between a plurality of accounts chosen by the distribution algorithm to include a single preselected account, or a plurality of preselected accounts as chosen by the user, and is connected to other components of the invention and or payment systems by online networks, phone networks, or other means of communication, and is done in accordance with the methods described by claim 8.

17. The system of claim 11 comprising a special proxy payment device issued by either administrators of the invention's systems, or issued by the administrators of the temporary credit facility, and said payment device can route payment or deposit transactions to or from the temporary credit facility, route transactions to or from the special proxy card network for further processing, or route transactions to be paid or deposited to or from a preselected account or accounts, and is done in accordance with systems and methods described by claim 8.

18. The method of claim 1 wherein deposited funds yet to be distributed to their target accounts, or debts owed from accounts targeted for distribution but not yet charged are securitized in a market traded security before debts are settled from or deposits are deposited to the user's other accounts.

19. The system of claim 11 comprising network connections to securities exchanges to provide for the securitization of deposits to be distributed, or debts owed but not yet charged to the accounts targeted for distribution, and securitized in a market traded security before debts are settled or deposits are deposited to the user's accounts.

20. The system of claim 11 comprising mechanisms that provides for the monitoring of all of a user's accounts against overage fees, monthly account maintenance charges, or other fees, that method comprising:
Software deployed on hardware that monitors accounts for any type of fee that can occur in an account, or any other charge or credit that may occur outside other systems of the present invention, to include a working schedule of monthly maintenance and other fees will occur in an account, which trigger a signal to the distribution algorithm;
online networks that monitor ACH networks, EFT networks, credit card networks, online banking portals, or other online payment systems, monitoring for fees, or transactions that would place an account below zero or minimum level, or otherwise a credit account over limit or over pay it, thus triggering a signal to mechanisms that transfer funds, such as the special proxy network, or ACH transactions, EFT transactions, or any other means of transferring funds between account;
on receipt of the signal, funds can be transferred between accounts to protect from the fee or overage, and this can also be done in accordance with the distribution algorithm, or some other manner that can be preselected by the user; and
said networks should be in accordance with protocols that are supplemented by fault detection software deployed within the system network to ensure all account monitoring functions yield accurate values, and account limits are not breached or over drafted.
